(19) United States
(12) Patent Application Publication
(10) Pub. No.: US 2012/0287414 A1
(43) Pub. Date: Nov. 15, 2012

(54) FACET MIRROR FOR USE IN MICROLITHOGRAPHY

(75) Inventors: Damian Fiolka, Oberkochen (DE); Joachim Hartjes, Aalen (DE)

(73) Assignee: Carl Zeiss SMT GmbH, Oberkochen (DE)

(21) Appl. No.: 13/547,357

(22) Filed: Jul. 12, 2012

Related U.S. Application Data
(63) Continuation of application No. PCT/EP2010/069456, filed on Dec. 13, 2010.

(30) Foreign Application Priority Data
Jan. 29, 2010 (DE) 102010001388.9

(51) Int. Cl. G03B 27/54; G02B 26/08

(52) U.S. Cl. 355/67; 359/216.1; 355/77

(57) ABSTRACT

A facet mirror (6; 10) serves for use in microlithography. The facet mirror (6; 10) has a plurality of facets (7; 11) which predefine illumination channels for guiding partial beams of EUV illumination light (3). At least some of the facets (7; 11) are displaceable via an adjusting device (30; 34) having an actuator (31; 35) with a movement component (32; dz′; dz″) perpendicular to a facet reflection plane (xy; x′y′; x″y″). This results in a facet mirror with which given requirements made of complying with desired illumination predefinitions that are to be achieved during the use of the facet mirror are achieved with lower production outlay in comparison with the prior art.

### CROSS-REFERENCE TO RELATED APPLICATIONS

This application is a continuation of, and claims priority under 35 USC 120 to, international application PCT/EP2010/069456, filed Dec. 13, 2010, which claims benefit under 35 USC 119 of German Application No. 10 2010 001 388.9, filed Jan. 29, 2010. International application PCT/EP2010/069456 is hereby incorporated by reference in its entirety.

### FIELD

The disclosure relates to a facet mirror for use in microlithography. Furthermore, the disclosure relates to an illumination optical unit for microlithography for illuminating an object field including at least one facet mirror of this type, an illumination system including such an illumination optical unit, a projection exposure apparatus including such an illumination system, a method for setting an illumination optical unit within such a projection exposure apparatus, a method for producing a micro- or nanostructured component using a projection exposure apparatus set in this way, and a patterned component fabricated by such a production method.

### BACKGROUND

A projection exposure apparatus including a facet mirror of the type mentioned in the introduction is known from US 2004/0108467 A1.

### SUMMARY

The disclosure provides a facet mirror for use in microlithography which assists in achieving desired illumination predefinitions with lower production outlay in comparison with certain known arrangements.

In one aspect, the disclosure provides a facet mirror for use in microlithography in which the facet mirror includes a plurality of facets which predefine illumination channels for guiding partial beams of illumination light. At least some of the facets are displaceable by an adjusting device having an actuator with a movement component perpendicular to a facet reflection plane. The adjusting device positions the facet along a total adjustment distance perpendicular to the facet reflection plane in the range of at least 1 mm. The adjusting device very finely influences a direction predefinition for the illumination channels assigned to the individual facets after reflection at the displaceable facets.

It has been recognized that the adjusting device according to the disclosure leads to the possibility of very finely influencing a direction predefinition for the illumination channels assigned to the individual facets after reflection at the adjustable facets. For given requirements made of an accuracy of the direction influencing, the requirements made of the adjusting device are correspondingly low. The adjusting device can have an open-loop or closed-loop control unit. The facet mirror with the adjusting device according to the disclosure can be embodied as a field facet mirror or as a pupil facet mirror. A displaceability with a movement component perpendicular to the facet reflection plane is provided even when the displacement direction deviates from a normal to the facet reflection plane. By way of example, between the displacement direction of the facets, which is given by the adjusting device, and the normal to the facet reflection plane there can be an angle in the range of 5°. A smaller angle, for example an angle of 3°, 2° or 1°, is also possible. A displacement exactly perpendicular to the facet reflection plane is also possible. Finally, the angle between the displacement direction and the normal to the facet reflection plane can also be greater than 5°.

The facet mirror according to the disclosure can be used, in particular, in EUV microlithography. Alternatively, it is also possible to use the facet mirror at other wavelengths, for example at UV or VUV wavelengths, for example at the illumination wavelength of 193 nm. The other assemblies according to the disclosure that are explained below can also be used at these other wavelengths.

In some cases, the adjusting device is particularly effective because there is a linear dependence of the deflection angle resulting from a displacement of the facet via the adjusting device and thus a corresponding dependence of the direction predefinition of the illumination channel guided via the displaced facet.

In certain cases, there is sufficient change in the illumination channel direction predefinition and thus sufficient adjustment swing of illumination parameters to be defined of an optical unit having as constituent part the facet mirror with the adjusting device according to the disclosure. A larger adjustment distance is also possible. Particularly when an adjustment distance larger than 1 mm can be achieved via the adjusting device, it is also possible to use shading effects between adjacent facets in a targeted manner.

In some cases, the positioning accuracy has been found to be sufficient in practice. Such a positioning accuracy is accessible with conventional adjusting mechanisms and with conventional adjusting actuators, for example with piezo-actuators or spindle actuators. The positioning accuracy can be better than 10 μm.

In certain cases, the actuator is a piezo-actuator which can be embodied with stacked piezoceramic elements. A tilting adjustment of the facets is also possible with corresponding piezo-actuators. Reference surfaces can be present in the region of the facets for predefining an initial position of the facet.

In some cases, an actuator can be embodied micromechanically. By the accuracy of a rotary positioning of a rotary drive for the spindle drive and via the thread pitch, it is possible to predefine firstly the total adjustment distance and secondly the positioning accuracy of the spindle drive. The spindle drive can be embodied as a precision drive with a differential thread.

Advantages of an illumination optical unit including a facet mirror described herein correspond to those disclosed above in connection with the facet mirror according to the disclosure. An illumination optical unit can be an illumination optical unit for use in EUV microlithography.

In some cases of an illumination optical unit, both an illumination angle distribution over the object field and an illumination intensity distribution over the object field can be finely adapted to predefined values.

For an illumination system disclosed herein and for a projection exposure apparatus disclosed herein, advantages correspond to those disclosed above with reference to the illumination optical unit according to the disclosure and the facet mirror according to the disclosure. With the projection exposure apparatus it is possible to realize micro- or nanostructured components, for example semiconductor chips, with high structure resolution. The light source of the projection exposure apparatus can be an EUV light source, a UV light source or a VUV light source, for example for generating illumination light having a wavelength of 193 nm.

A method for setting the illumination optical unit can use a facet mirror with the adjusting device according to the disclosure. A measuring device can have a CCD array or some other spatially resolving detection element. A CCD array of this type, by virtue of corresponding equipment, can be sensitive to the illumination light. Alternatively, it is possible to design the measuring device such that it is possible to use, for example, a CCD array or some other spatially resolving detection element which is sensitive to an adjusting light wavelength. With the aid of the setting method according to the disclosure, it is possible to achieve illumination parameters also with inclusion of an allowance of effects of the projection optical unit or of the light source which affect the projection exposure within predefined tolerance ranges. In this way, it is possible to compensate for such effects of the projection optical unit or of the light source via the facet adjustment. The measurement can be effected via a measuring device having a measuring unit in the region of the object field and a further measuring unit in the region of the pupil facet mirror. As a result, in cases in which both a field facet mirror and a pupil facet mirror have the adjusting device according to the disclosure, the effects of the respective adjustments of field and of pupil facets can be detected separately.

In some cases, the adjusting device can be used for optimizing an illumination intensity over the field height of the object field. As a result, the mode of operation of a field intensity predefinition device can be improved, which is described, for example, in WO 2009/074 211 A1.

In certain cases, the field intensity predefinition device and the facet mirror cooperate with the adjusting device according to the disclosure for predefining an illumination intensity distribution over the field height. This cooperation can take place iteratively.

Advantages of a production method disclosed herein and of a component disclosed herein can correspond to those disclosed above.

### BRIEF DESCRIPTION OF THE DRAWINGS

Exemplary embodiments of the disclosure are explained in greater detail below with reference to the drawing, in which:

FIG. 1 shows schematically and with regard to an illumination optical unit in meridional section a projection exposure apparatus for microlithography;

FIG. 2 shows an excerpt enlargement from FIG. 1 in the region of a reticle or object plane;

FIG. 3 shows a view of a field intensity predefinition device of the projection exposure apparatus from viewing direction III in FIG. 2;

FIG. 4 shows a view of a facet arrangement of a field facet mirror of the illumination optical unit of the projection exposure apparatus according to FIG. 1;

FIG. 5 shows a view of a facet arrangement of a pupil facet mirror of the illumination optical unit of the projection exposure apparatus according to FIG. 1;

FIG. 6 shows, in an illustration similar to FIG. 4, a facet arrangement of a further embodiment of a field facet mirror;

FIG. 7 shows with regard to a beam path of EUV illumination light more highly schematically and with regard to an adjustability of facets of a field facet mirror and of a pupil facet mirror further details showing the illumination optical unit of the projection exposure apparatus according to FIG. 1;

FIG. 8 shows schematically and perspectively a pupil facet of the pupil facet mirror of the illumination optical unit with a piezo-adjusting device for adjusting the pupil facet perpendicular to a facet reflection plane;

FIG. 9 shows schematically an excerpt from a beam path of the EUV illumination light according to FIG. 7 for elucidating the effects of an adjustment of a field facet of the field facet mirror of the illumination optical unit;

FIG. 10 shows schematically in a plan view in the direction of an object plane the effect of an adjustment of facets on specific illumination channels assigned to the facets, the field intensity predefinition device additionally being illustrated;

FIG. 11 shows, in an illustration similar to FIG. 10, the effects of an adjustment of individual field facets on an illumination of pupil facets of the pupil facet mirror of the illumination optical unit;

FIG. 12 shows in a schematic side view the effects of the mutual shading of two adjacent facets; and

FIG. 13 shows, in an illustration similar to FIG. 8, a pupil facet with a further embodiment of an adjusting device with a spindle drive.

### DETAILED DESCRIPTION

A projection exposure apparatus 1 for microlithography serves for producing a micro- or nanostructured electronic semiconductor component. A light source 2 emits EUV radiation used for illumination in the wavelength range of, for example, between 5 nm and 30 nm. The light source 2 can be a GDPP source (gas discharge produced plasma) or an LPP source (laser produced plasma). A radiation source based on a synchrotron can also be used for the light source 2. Information concerning a light source of this type can be found by the person skilled in the art in U.S. Pat. No. 6,859,515 B2, for example. EUV illumination light or illumination radiation 3 is used for illumination and imaging within the projection exposure apparatus 1. Downstream of the light source 2, the EUV illumination light 3 firstly passes through a collector 4, which can be, for example, a nested collector having a multi-shell construction known from the prior art or, alternatively, an ellipsoidally shaped collector. A corresponding collector is known from EP 1 225 481 A. Downstream of the collector 4, the EUV illumination light 3 firstly passes through an intermediate focal plane 5, which can be used for separating the EUV illumination light 3 from undesired radiation or particle portions. After passing through the intermediate focal plane 5, the EUV illumination light 3 firstly impinges on a field facet mirror 6.

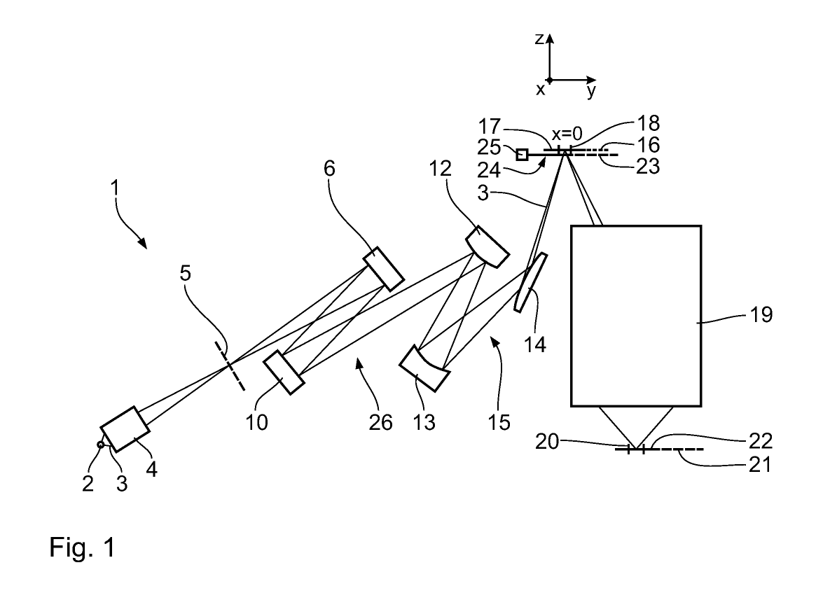

In order to facilitate the description of positional relationships, a Cartesian global xyz coordinate system is in each case depicted in the drawing. In FIG. 1, the x-axis runs perpendicular to the plane of the drawing and out of the latter. The y-axis runs toward the right in FIG. 1. The z-axis runs upward in FIG. 1.

In order to facilitate the description of positional relationships in the case of individual optical components of the projection exposure apparatus 1, a Cartesian local xyz or xy coordinate system is in each case also used in the following figures. The respective local xy coordinates span, unless described otherwise, a respective principal arrangement plane of the optical component, for example a reflection plane. The x-axes of the global xyz coordinate system and of the local xyz or xy coordinate systems run parallel to one another. The respective y-axes of the local xyz or xy coordinate systems have an angle with respect to the y-axis of the global xyz coordinate system, which corresponds to a tilting angle of the respective optical component about the x-axis.

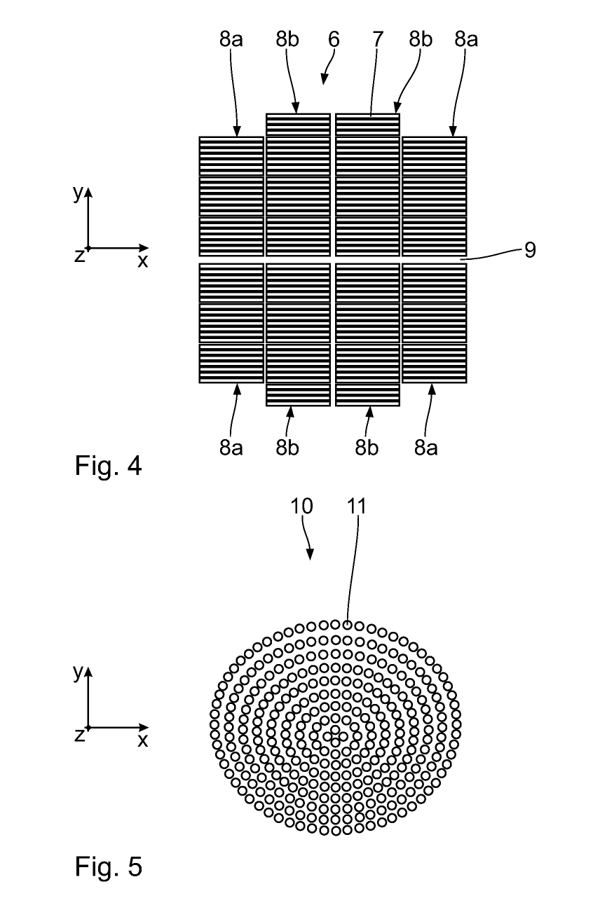

FIG. 4 shows, by way of example, a facet arrangement of field facets 7 of the field facet mirror 6. The field facets 7 are rectangular and each have the same x/y aspect ratio. The x/y aspect ratio can be for example 12/5, can be 25/4 or can be 104/8.

The field facets 7 predefine a reflection surface of the field facet mirror 6 and are grouped in four columns each having six to eight field facet groups 8a, 8b. The field facet groups 8a each have seven field facets 7. The two additional marginal field facet groups 8b of the two central field facet columns each have four field facets 7. Between the two central facet columns and between the third and fourth facet rows, the facet arrangement of the field facet mirror 6 has interspaces 9, in which the field facet mirror 6 is shaded by holding spokes of the collector 4.

After reflection at the field facet mirror 6, the EUV illumination light 3 split into beams or partial beams which are assigned to the individual field facets 7 impinges on a pupil facet mirror 10.

FIG. 5 shows an exemplary facet arrangement of round pupil facets 11 of the pupil facet mirror 10. The pupil facets 11 are arranged around a center in facet rings situated one in another. A pupil facet 11 is assigned to each partial beam of the EUV illumination light 3 reflected by one of the field facets 7, such that a respective facet pair impinged upon and including one of the field facets 7 and one of the pupil facets 11 predefines an illumination channel for the associated partial beam of the EUV illumination light 3. The channel-by-channel assignment of the pupil facets 11 to the field facets 7 is effected depending on a desired illumination by the projection exposure apparatus 1.

Via the pupil facet mirror 10 (FIG. 1) and a downstream transfer optical unit 15 consisting of three EUV mirrors 12, 13, 14, the field facets 7 are imaged into an object plane 16 of the projection exposure apparatus 1. The EUV mirror 14 is embodied as a mirror for grazing incidence (grazing incidence mirror). Arranged in the object plane 16 is a reticle 17, from which, with the EUV illumination light 3, an illumination region is illuminated which coincides with an object field 18 of a downstream projection optical unit 19 of the projection exposure apparatus 1. The illumination channels are superimposed in the object field 18. The EUV illumination light 3 is reflected from the reticle 17.

The projection optical unit 19 images the object field 18 in the object plane 16 into an image field 20 in an image plane 21. Arranged in the image plane 21 is a wafer 22, which bears a light-sensitive layer that is exposed during the projection exposure via the projection exposure apparatus 1. During the projection exposure, both the reticle 17 and the wafer 22 are scanned in a synchronized manner in the y-direction. The projection exposure apparatus 1 is embodied as a scanner. The scan direction is also designated hereinafter as object displacement direction.

Arranged in a field intensity predefinition plane 23 is a field intensity predefinition device or field correction device 24, which will be explained in greater detail below. The field intensity predefinition device 24, which is also designated as UNICOM, serves for setting a scan-integrated, that is to say integrated in the y-direction, intensity distribution over the object field 18. The field intensity predefinition device 24 is driven by a control device 25. An example of a field correction device is known from EP 0 952 491 A2 and from DE 10 2008 013 229 A1.

The field facet mirror 6, the pupil facet mirror 10, the mirrors 12 to 14 of the transfer optical unit 15 and the field intensity predefinition device 24 are parts of an illumination optical unit 26 of the projection exposure apparatus 1. Together with the projection optical unit 19 the illumination optical unit 26 forms an illumination system of the projection exposure apparatus 1.

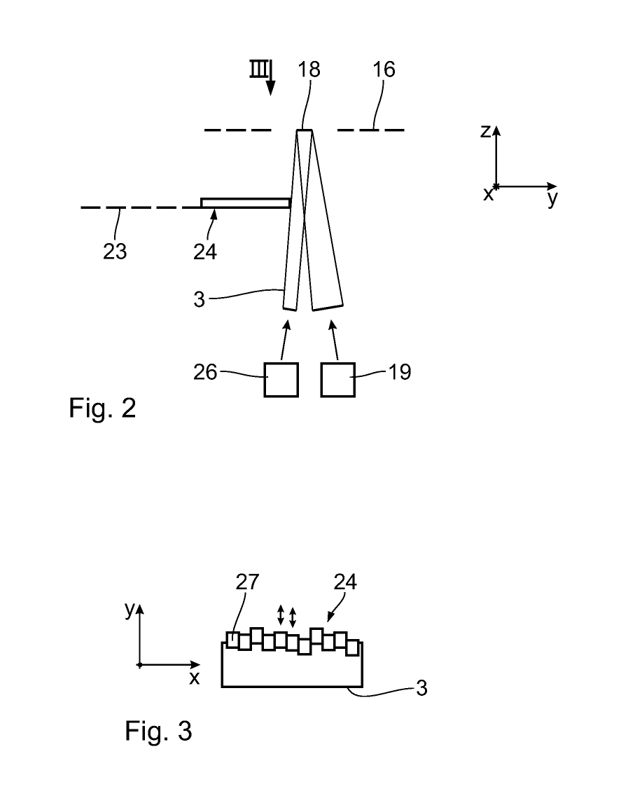

FIGS. 2 and 3 show the field intensity predefinition device 24 in greater detail. The field intensity predefinition device 24 has a plurality of finger-like individual diaphragms 27 arranged alongside one another. By way of example, twenty-six individual diaphragms 27 having a respective width of 4 mm occur in the case of the embodiment according to FIGS. 2 and 3. The individual diaphragms 27 are either directly adjacent or else partly overlapping. In the case of a partial overlap, adjacent individual diaphragms 27 lie in planes that are as closely adjacent to one another as possible perpendicular to the ray direction of the EUV illumination light 3.

All of the individual diaphragms 27 are inserted into the EUV illumination light 3 from one and the same side.

With the aid of the control device 25, the individual diaphragms 27 can be set into a predefined position in the y-direction independently of one another. Depending on the field height, that is to say the x-position, at which an object point on the reticle 17 passes the object field 18, the scanning distance of the object point in the y-direction and thus the integrated intensity of the EUV illumination light 3 that is experienced by the object point are determined by the y-position of the respective individual diaphragm 27. In this way, a homogenization or a predefined distribution of the intensity of the EUV illumination light 3 which illuminates the reticle 17 can be achieved via a predefinition of the y-positions of the individual diaphragms 27.

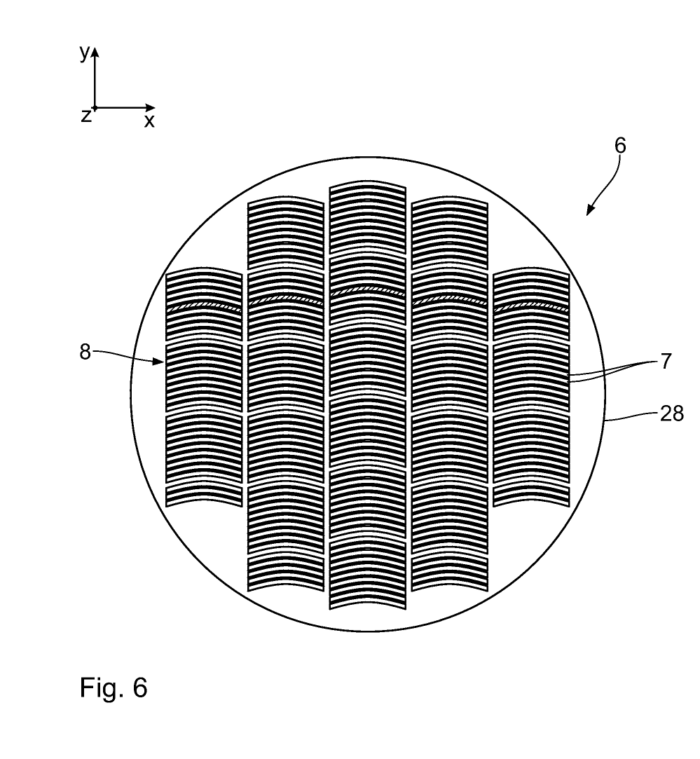

FIG. 6 shows a further embodiment of a field facet mirror 6. Components corresponding to those which have been explained above with reference to the field facet mirror 6 according to FIG. 4 bear the same reference numerals and are only explained insofar as they differ from the components of the field facet mirror 6 according to FIG. 4. The field facet mirror 6 according to FIG. 6 has a field facet arrangement including curved field facets 7. The field facets 7 are arranged in a total of five columns each having a plurality of field facet groups 8. The field facet arrangement is inscribed into a circular boundary of a carrier plate 28 of the field facet mirror.

The field facets 7 of the embodiment according to FIG. 6 all have the same area and the same ratio of width in the x-direction and height in the y-direction, which corresponds to the x/y aspect ratio of the field facets 7 of the embodiment according to FIG. 4.

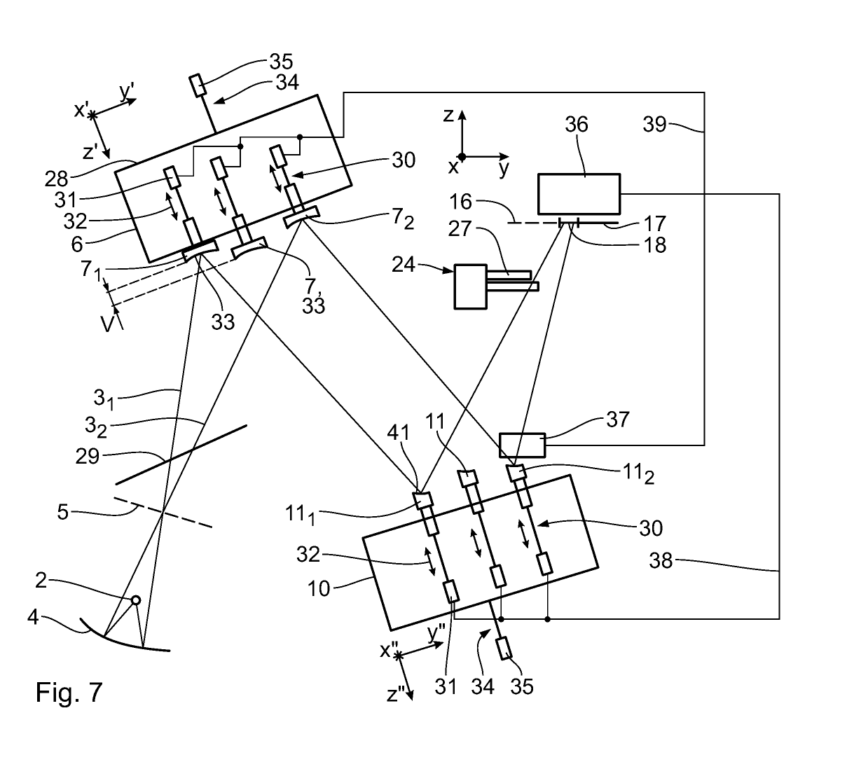

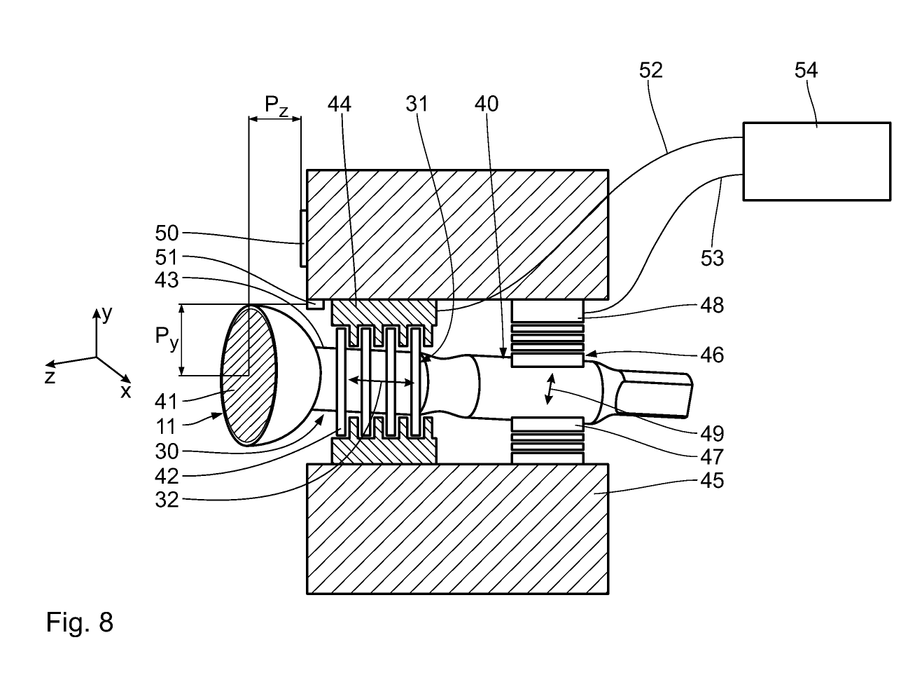

With reference to FIG. 7, which represents a beam path of the EUV illumination light 3 more highly schematically in comparison with FIG. 1 and with omission of the transfer optical unit 15, further details of the illumination optical unit 26 are explained below. Components corresponding to those which have already been explained above with reference to FIGS. 1 to 6 bear the same reference numerals and will not be discussed in detail again.

A local coordinate system for the field facet mirror 6 and the field facets 7 is depicted as an x′y′z′ coordinate system in FIG. 7. A local x″y″z″ coordinate system for the pupil facet mirror 10 and the pupil facets 11 is also correspondingly depicted in FIG. 7.

In FIG. 7, a spectral filter 29 is also indicated schematically between the intermediate focal plane 5 and the field facet mirror 6, which filter can also be a deflection mirror for the EUV illumination light 3. The spectral filter 29 suppresses wavelength portions of the EUV illumination light 3 that are not used as used radiation, more particularly long-wave portions.

In FIG. 7, firstly the field facet mirror 6 is illustrated schematically with three field facets 7, and secondly the pupil facet mirror 10 is illustrated schematically with three pupil facets 11. It goes without saying that a significantly larger number of field facets 7 and pupil facets 11 are used in practice.

The field facets 7 are configured such that they are tiltable between two stops (not illustrated), wherein a specific one of the pupil facets 11 is assigned to each of the two tilting positions via an illumination channel. In this way, one of two possible illumination channels and accordingly one of two possible pupil facets 11 can be selected via the predefinition of the tilting position of the field facet 7. In the case of the illumination optical unit 26, the pupil facet mirror 10 therefore has twice as many facets as the field facet mirror 6. The associated stops and the tilting actuators are not illustrated in FIG. 7.

FIG. 7 illustrates two illumination channels 3₁ and 3₂ of the EUV illumination light 3. The field facet 7₁ and the pupil facet 11₁ are assigned to the illumination channel 3₁. The field facet 7₂ and the pupil facet 11₂ are assigned to the illumination channel 3₂.

Each of the field facets 7 has an adjusting device 30 having an actuator 31 in the form of a linear actuator. The adjusting device 30 serves for adjusting the associated field facet 7 along a displacement direction (double-headed arrow 32) with a movement component z′ perpendicular to a facet reflection plane x′y′.

The field facets 7 have a curved, more particularly a concavely curved, reflection surface 33.

The adjusting device 30 is embodied in such a way as to provide a positioning of the respective field facet 7 along a total adjustment distance V perpendicular to the field facet reflection plane x′y′ in the range of at least 1 mm and, in the case of the embodiment described, of 2 mm. In FIG. 7, the field facet 7₁ illustrated on the left is illustrated in a maximally retracted adjustment position and the central field facet 7 is illustrated in a maximally extended field position, such that the z′-positions of these two field facets 7 illustrate the total adjustment distance V.

A positioning accuracy of the field facets 7 along the total adjustment distance V is in the range of less than 25 μm and, in the case of the embodiment described, is 10 μm.

A further adjusting device 34 having a linear actuator 35 is connected to the carrier plate 28 of the field facet mirror 6, such that the field facet mirror 6 with all of the field facets 7 all together can be displaced via the adjusting device 34 in the z′-direction for predefining a z′-offset.

In the same way, the pupil facets 11 are also equipped with adjusting devices 30 having actuators 31 and the entire pupil facet mirror 10 is equipped with an adjusting device 34 having a linear actuator 35, such that firstly the individual pupil facets 11 and secondly the entire pupil facet mirror 10 can be displaced along a displacement direction 32 and z″, respectively, with a movement component perpendicular to an x″y″ reflection plane of the pupil facets 11.

The projection exposure apparatus 1 includes a measuring device having measuring units 36, 37 for measuring an actual illumination intensity distribution of the EUV illumination light 3, which is able to resolve the contribution of individual illumination channels. The object field measuring unit 36 is arranged in the region of the object plane 16, to be precise in the EUV beam path downstream of the reticle 17, such that the object field measuring unit 36 can measure an illumination of the object field 18, as long as the reticle 17 is removed. The object field measuring unit 36 can be a CCD array which, by virtue of corresponding equipment, is sensitive to the EUV illumination light 3. Alternatively, the object field measuring unit 36 can also be sensitive to an adjusting light wavelength, the intensity distribution of which corresponds to that of the EUV illumination light 3.

The object field measuring unit 36 is signal-connected via a signal line 38 to the adjusting devices 30 of the pupil facet mirror 10. The object field measuring unit 36 can also, this not being illustrated, be signal-connected via a further signal line to the adjusting device 34 of the pupil facet mirror 10 and the adjusting devices 30, 34 of the field facet mirror 6.

The pupil measuring unit 37 can be introduced into the beam path of the EUV illumination light 3 between the pupil facet mirror 10 and the object field 18 and detects an actual illumination intensity distribution on one of the pupil facets 11, as illustrated in FIG. 7 with regard to the pupil facet 11₂, or on all of the pupil facets 11. The pupil measuring unit 37 can likewise be embodied as a CCD array. The pupil measuring unit 37 is signal-connected via a signal line 39 to the adjusting devices 30 of the field facet mirror 6. The pupil measuring unit 37 can also, this not being illustrated, be signal-connected via a further signal line to the adjusting device 34 of the field facet mirror 6 and to the adjusting devices 30, 34 of the pupil facet mirror 10.

The two measuring units 36, 37 can also be signal-connected to one another for exchanging data or control signals via a signal line (not illustrated).

FIG. 8 shows an embodiment of one of the pupil facets 11 with an exemplary embodiment of the adjusting device 30. Components corresponding to those which have already been explained above with reference to FIGS. 1 to 7 bear the same reference numerals and will not be discussed in detail again.

As actuator 31, the adjusting device 30 according to FIG. 8 has a piezo-actuator. A pin-shaped facet carrier 40, at one end of which the pupil facet 11 having a concave reflection surface 41 is integrally formed, carries in an axial section a plurality of piezoceramic elements 42 spaced apart axially from one another. FIG. 8 illustrates four piezoceramic elements 42 of this type, each having the form of a circumferential collar around a lateral surface wall 43 of the facet carrier 40. The piezoceramic elements 42 spaced apart axially from one another engage marginally into stacks 44 of piezoelements, so-called piezostacks, which are shaped complementarily thereto. The stacks 44 are carried by a carrier-plate-fixed facet mirror frame 45, which simultaneously constitutes a heat sink. Via the piezo-actuator 31, it is possible to adjust the pupil facet 11 along the displacement direction 32, that is to say in the z-direction according to FIG. 8.

Further piezo-actuators 46 make it possible to tilt the pupil facet 11 about tilting axes parallel to the y-axis and to the x-axis. FIG. 8 illustrates the piezo-actuator 46 that makes possible the x-axis tilting. The otherwise identically constructed piezo-actuator for the y-axis tilting is arranged correspondingly perpendicularly thereto by 90°.

The piezo-actuator 46 has piezoceramic elements 47 mounted areally on the lateral surface wall 43 of the facet carrier 40 and stacks 48 of piezoelements spaced apart radially from the piezoceramic elements. The stacks 48 are in turn carried by the facet mirror frame 45. A tilting (double-headed arrow 49 in FIG. 8) via the piezo-actuator 46 is effected by the predefinition of a radial attractive force between the stacks 48 and the piezoceramic elements 47.

The facet mirror frame 45 furthermore bears two reference surfaces, namely a Z-reference surface 50 and a Y-reference surface 51. A further X-reference surface, with which an X-position or an X-precision dimension Pₓ of the pupil facet 11 can be determined, is not illustrated in FIG. 8.

A Z-precision dimension P_{z} can be predefined via the Z-reflection surface 50 with the aid of an optical measurement. A Y-precision dimension P_{y} can correspondingly be predefined optically via the y-reference surface 51.

The piezostacks 44, 48 are signal-connected via signal lines 52, 53 to an open-loop or closed-loop control unit 54 of the adjusting device 30. The open-loop or closed-loop control unit 54 is in turn signal-connected to the pupil measuring unit 37 (cf. FIG. 7) and to a detection and evaluation unit (not illustrated) for the precision dimensions Pₓ, P_{y} and P_{z}.

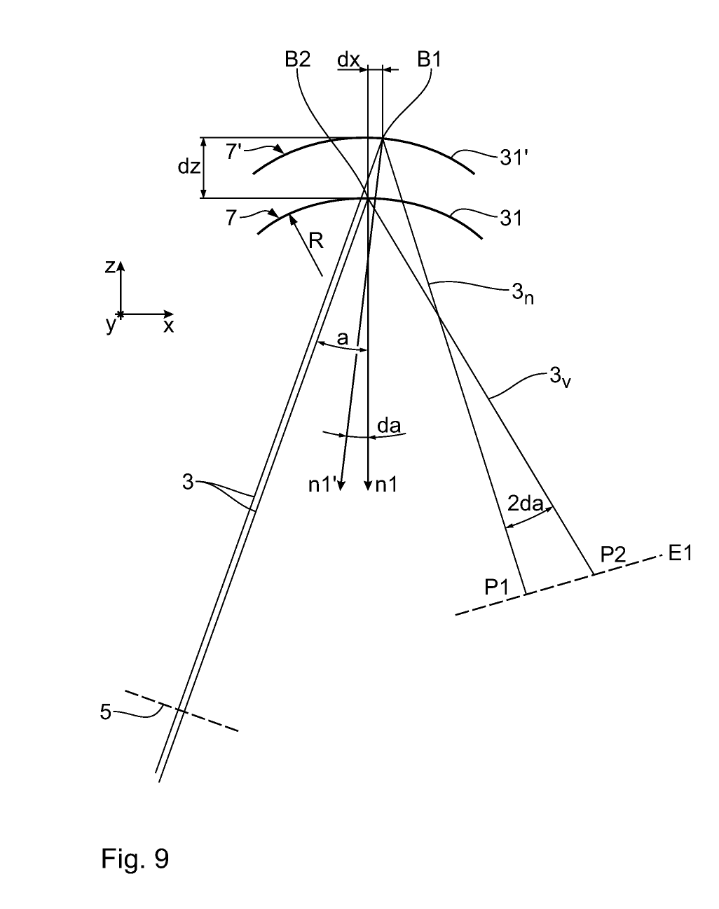

FIG. 9 illustrates the effect of an adjustment of a field facet 7 by a displacement distance dz within the total adjustment distance V on the ray guiding of an illumination channel of the EUV illumination light 3. FIG. 9 illustrates the deflecting effect on account of a displacement by dz in a greatly exaggerated fashion, since the displacement is illustrated in an excessively increased fashion and since the radius of curvature is illustrated as very exaggeratedly small. The illustration shows the beam path of the illumination channel 3ᵥ before the displacement of the field facet 7 and the beam path 3ₙ after the displacement by dz in the positive z-direction. After the displacement, the field facet is illustrated at 7′.

The displacement of the field facet 7 by the associated adjusting device 30 (not illustrated in FIG. 9) runs in the z-direction, that is to say perpendicular to the facet reflection plane, that is to say the xy plane. An angle between the displacement direction and the z-direction that is greater than 0°, for example an angle of 1°, 2°, 3°, 5° or an even greater angle between the displacement direction and the normal to the facet reflection plane, is also possible.

Before the displacement, the illumination channel impinges on the field facet 7 at a point B2 and has there an angle a of incidence with respect to a normal vector n1 relative to the reflection surface 31 of the field facet 7 at the point B2. The curved reflection surfaces 31 of the field facets 7 have a radius R of curvature.

Proceeding from the point B2, the illumination channel 3ᵥ is reflected toward a point P2 in a plane E1 disposed downstream of the field facet mirror 6 in the beam path of the EUV illumination light 3, for example a principal reflection plane, in which the pupil facet mirror 10 is arranged.

The displacement of the field facet 7 by actuation of the corresponding adjusting device 30 by the adjustment distance dz has the effect that the EUV illumination light 3ₙ of the illumination channel is now reflected at the reflection surface 31′ of the pupil facet 7′ at the point B1. The point B1 is spaced apart from the point B2 by a distance dx in the x-direction of the local Cartesian xyz coordinate system with respect to the field facet 7 in FIG. 9. This is owing to the fact that the EUV illumination light 3 does not impinge on the pupil facet 7 parallel to the z-direction, but rather at an angle with respect thereto. At the impingement point B1, the reflection surface 31 has a normal vector n1′. The two normal vectors n1, n1′ form an angle da with respect to one another, as illustrated again at the top on the right in FIG. 9. The angle of incidence of the EUV illumination light 3 at the point B1 is correspondingly a-da. After reflection at the point B1, the beam path 3ₙ of the EUV illumination light 3 runs toward a point P1 in the plane E1.

On account of the displacement dz, there arises a change in the ray direction of the associated illumination channel, that is to say a change in the direction between the beam paths 3ᵥ and 3ₙ, by an angle 2da. The following holds true:

da˜a dz/R

da is therefore directly proportional to a and to dz and indirectly proportional to R. The smaller the radius R of curvature of the reflection surface 31, the more strongly a displacement by dz therefore affects the change in direction of the illumination channel of the EUV illumination light 3 that is reflected by the field facet 7.

Given a radius R of curvature of the order of magnitude of 1 m and an average angle a of incidence in the range of 15°, a change in the normal vector da in the range of between 0 and 500 μrad arises as a result of a height adjustment dz in the range of 1 mm.

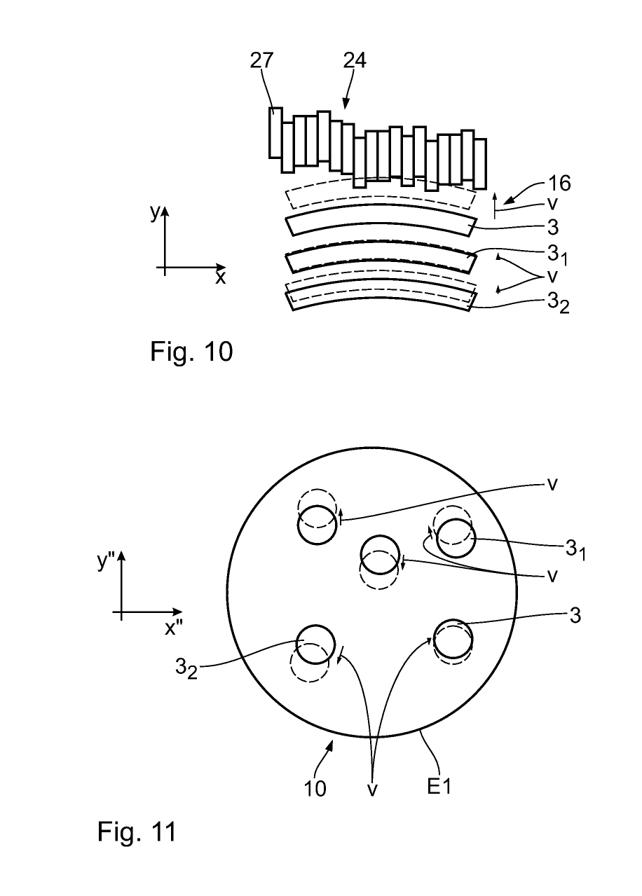

FIG. 11 illustrates the effect of an adjustment of field facets 7 by adjustment distances dz' of the local x′y′z′ coordinate system of the field facet mirror 6 according to FIG. 7 on the position of the respective illumination channels 3₁, 3₂ and of further illumination channels 3. The illumination in the arrangement plane E1 of the pupil facet mirror 10 before a displacement of the field facets 7 by dz′ is illustrated by solid lines and the position of the illumination channels 3₁, 3₂ and 3 after the displacement of the field facets 7 by dz′ is illustrated by dashed lines. The absolute value and the direction of the respective displacement of the illumination channels 3₁, 3₂ and 3 in the arrangement plane 1, that is to say in the xy plane according to FIG. 10, are respectively illustrated by a direction arrow v in FIG. 10. This change in the impingement points of the illumination channels 3₁, 3₂ and 3 on the pupil facet mirror 10 leads to a corresponding change in an illumination angle distribution during the illumination of the object field 18. The adjustment of the field facets 7 by respective adjustment distances dz′ can therefore be used for the fine tuning of the illumination angle distribution, that is to say can be used as a so-called PUPICOM, that is to say as an illumination angle predefinition device for the illumination of the object field 18. An illumination angle predefinition device of this type can influence an intensity distribution of the illumination light 3 in a pupil plane of the illumination optical unit 26.

FIG. 10 shows the corresponding conditions in the case of a displacement of the pupil facets 11 by adjustment distances dz″ in accordance with the local x″y″z″ coordinate system of the pupil facet mirror 10 according to FIG. 7. Once again the illumination channels 3₁, 3₂ and a further illumination channel 3 before the displacement of the pupil facets 11 by the adjustment distance dz″ are illustrated by solid lines and the same illumination channels 3₁, 3₂ and 3 after the displacement of the pupil facets 11 by the adjustment distance dz″ are illustrated by dashed lines. The absolute value and the direction of the respective displacement of the illumination channels 3₁, 3₂ and 3 on the pupil facet mirror 10 are in each case illustrated by a direction arrow v in FIG. 10. The result is a corresponding displacement of the respective illumination channel in the object plane 16, that is to say a displacement of the position of the respective field facet image. This displacement on account of an adjustment of the pupil facets 11 by the adjustment distance dz″ can be used for optimizing the superimposition of the illumination channels of the EUV illumination light 3 in the object field 18.

A displacement of the field facets 7 by respective adjustment distances dz′ leads, alongside a displacement of the illumination channels in the plane E1, additionally to a change in direction of the illumination channels upon impinging on the object plane 16. A pair of adjustment distances dz′, dz″ within an illumination channel of the EUV illumination light 3 therefore predefines two degrees of freedom, with which it is possible to achieve, for example, a specific illumination angle without altering a position of the field facet image in the object plane 16. This can also be used to predefine an illumination channel 3 in terms of its direction such that undesired or disturbing effects of the field intensity predefinition device 24 on an illumination angle distribution of the object field 18 are minimized.

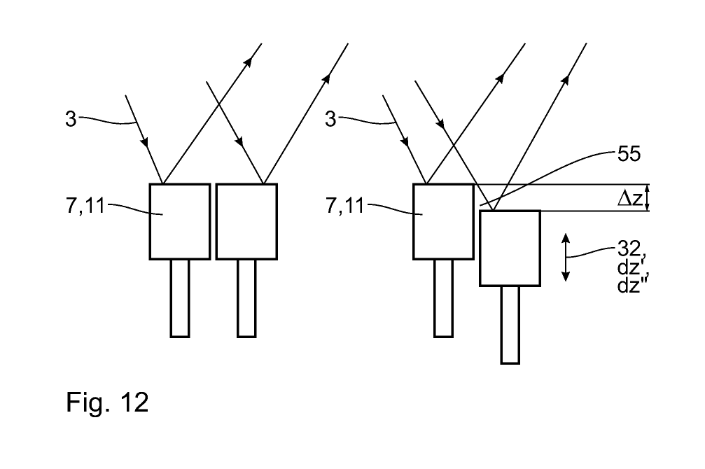

FIG. 12 illustrates that an adjustment along the displacement direction 32, that is to say by an adjustment distance dz′ or dz″, in the case of adjacent field or pupil facets 7, 11, can lead to a partial shading of an illumination channel of the EUV illumination light 3, which can likewise be used for correcting a field or illumination angle intensity distribution in the object field 18. In FIG. 12 on the left, two adjacent facets 7, 11 have the same z-position, such that no shading effect results. In FIG. 12 on the right, two adjacent facets 7, 11 have a position difference Δz in the displacement direction 32, such that the EUV illumination light 3 is shaded in a shading region 55. If the facet on which the shading region 55 lies is a field facet 7, the shading region 55 does not contribute to the imaging on the object field 18, which can be used for field intensity correction. If the facet with the shading region 55 is a pupil facet 11, the shading region 55 does not contribute to the illumination from the direction of the pupil facet, which can be used for illumination angle correction, for example for correcting an ellipticity value or a telecentricity value. A definition of corresponding ellipticity and telecentricity values can be found in WO 2009/074 211 A1.

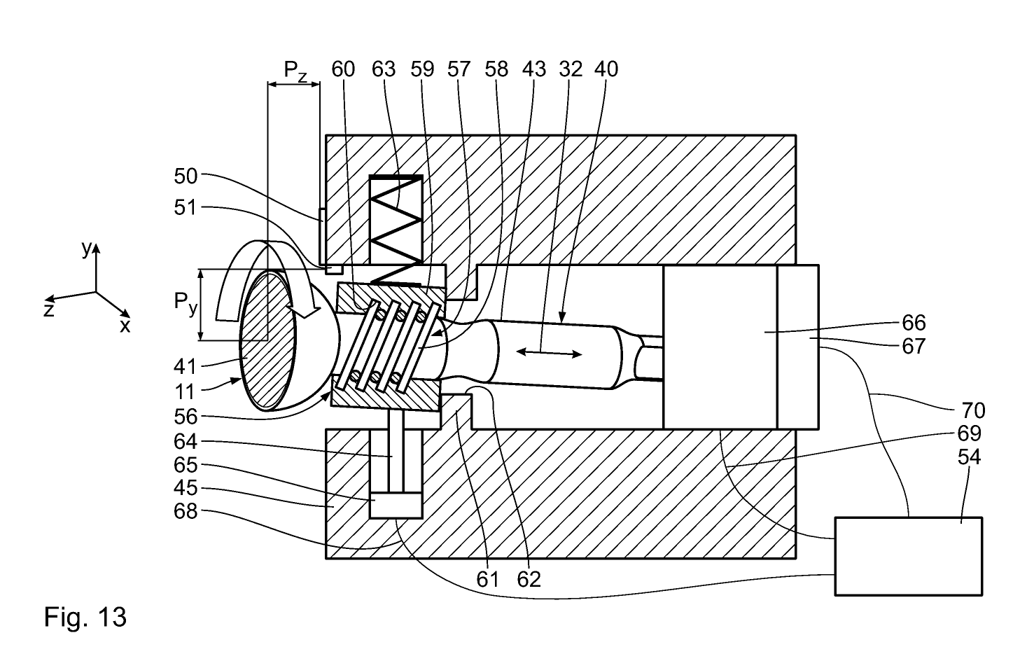

FIG. 13 shows a further embodiment of an adjusting device 56 for adjusting a pupil facet 11 along the displacement direction 32 or along the z-direction of the local xyz coordinate system of the pupil facet 11. Components corresponding to those which have already been explained above with reference to FIGS. 1 to 12, and in particular with reference to FIG. 8, bear the same reference numerals and will not be discussed in detail again.

In the case of the embodiment according to FIG. 13, an actuator for displacing the reflection surface 41 of the pupil facet 11 in the z-direction is embodied as a spindle drive 57. The spindle drive 57 has an external thread 58, which is embodied in the lateral surface wall 43 of the facet carrier 40 adjacent to the reflection surface 41. Furthermore, the spindle drive 57 has a threaded body 59 carried by the facet mirror frame 45. The threaded body 59 has an internal thread 60 complementary to the external thread 58.

The threaded body 59 is held axially by a circumferential rib 61 of the facet mirror frame 45. The circumferential rib 61 has a through-opening 62, through which the facet carrier 40 is inserted. The threaded body 59 is radially mounted between a resilient restoring element 63, which is supported between the threaded body 59 and the facet mirror frame 45, and a connecting element 64 of a lateral drive 65. The lateral drive 65, which brings about a y-tilting adjustment of the pupil facet 11, can be a microlinear motor or a piezo-actuator in the manner of the piezo-actuator 46 according to FIG. 8. In the same way, the adjusting device 56 also has a further lateral drive for the x-tilting adjustment of the pupil facet mirror 11.

For adjustment along the displacement direction 32, that is to say along the facet carrier 40, which corresponds to a Z-adjustment of the pupil facet mirror 11, the facet carrier 40 is rotated about its longitudinal axis. For this purpose, an end of the facet carrier 40 facing away from the reflection surface 41 is connected to a rotary drive 66 in the form of a micro-motor. The latter constitutes a structural unit with a rotary measuring transducer 67. The drives, that is to say in particular the lateral drive 65 and the rotary drive 66 with the rotary measuring transducer 67, are signal-connected via signal lines 68, 69, 70 to the open-loop or closed-loop control unit 54.

The spindle drive 57 can be embodied as a precision drive with a differential thread.

The following procedure is adopted for setting the illumination optical unit 26 for predefining a desired illumination intensity distribution and a desired illumination angle distribution over the object field 18: firstly, an actual illumination intensity distribution of the EUV illumination light 3 is measured via the measuring units 36, 37, which can resolve the contributions of individual illumination channels of the EUV illumination light 3. Afterward, at least one of the facets 7, 11 is adjusted via the associated actuator 31, 35, 57 of the respective adjusting device 30, 34, 56 along the displacement direction 32 until the respectively measured actual illumination intensity distribution over the object field 18 corresponds to a desired illumination intensity distribution within a predefined tolerance range.

When measuring the actual illumination intensity distribution of the EUV illumination light 3, the distribution of the intensity of the illumination light 3 over the field height, that is so say along the x-direction, can be measured via the measuring unit 36. Afterward, an adjustment of at least one of the facets 7, 11 along the displacement direction 32 can be performed, as has already been explained above, until the actual illumination intensity distribution over the field height x corresponds to the desired illumination intensity distribution within the predefined tolerance range.

Alternatively or additionally, via the measuring unit 37, it is possible to carry out a measurement of the illumination intensity on selected or on all pupil facets 11 and, on the basis of this measurement result, to carry out the adjustment of the facets 7, 11 along predefined displacement distances dz′, dz″ in order to obtain a desired illumination intensity and illumination angle distribution over the object field 18.

If appropriate, the displacement of the facets 7, 11 along the respective displacement direction 32 is accompanied by a tilting angle correction about the respective x- and y-axes of the local coordinate systems of the field facets 7, 11. This correction can take place together with the displacement along the displacement distance 32 in an iterative process.

In particular a fine adjustment of direction components of the illumination channels of the EUV illumination light upstream of the object field 18 in the scanning direction, that is to say in the Y-direction, is possible, which in interaction with the individual diaphragms 27 of the field intensity predefinition device 24 ensures good control of the illumination intensity over the field height.

An ultrasonic motor, in particular, can be used as piezo-actuator.

An adjustment of the individual diaphragms 27 of the field intensity predefinition device 24 and an adjustment of the facets 7, 11 along the displacement direction 32 can be effected iteratively in order to predefine a desired illumination intensity distribution over the field height x.

During the projection exposure, the reticle 17 and the wafer 22, which bears a coating that is light-sensitive to the EUV illumination light 3, are provided. Afterward, at least one section of the reticle 17 is projected onto the wafer 22 with the aid of the projection exposure apparatus 1. Finally, the light-sensitive layer exposed with the EUV illumination light 3 on the wafer 22 is developed. In this way, the micro- or nanostructured component, for example a semiconductor chip, is produced.

The exemplary embodiments described above have been described on the basis of EUV illumination. As an alternative to EUV illumination, it is also possible to use UV or VUV illumination, for example with illumination light having a wavelength of 193 nm.

What is claimed is:

1. A facet mirror, comprising:
a plurality of facets configured to predefine illumination channels to guide partial beams of light, the plurality of facets including a first facet; and
an adjusting device configured to displace the first facet, the adjusting device comprising an actuator having a movement component perpendicular to a facet reflection plane,
wherein the adjusting device is configured to position the first facet along a total adjustment distance perpendicular to the facet reflection plane of at least 1 mm, the adjusting device is configured to very finely influence a direction predefinition for the illumination channel of the first facet after reflection at the first facet, and the facet mirror is configured to be used in microlithography.

2. The facet mirror of claim 1, further comprising a plurality of adjusting devices, each adjusting device being configured to displace a corresponding facet, each adjusting device comprising an actuator having a movement component perpendicular to the facet reflection plane, each adjusting device being configured to position its corresponding facet along a total adjustment distance perpendicular to the facet reflection plane of at least 1 mm, and each adjusting device being configured to very finely influence a direction predefinition for the illumination channel of its corresponding facet after reflection at the corresponding facet.

3. The facet mirror of claim 1, wherein each facet comprises a curved reflection surface.

4. The facet mirror of claim 1, the adjusting device is configured to position the first facet along the adjustment distance within a range of less than 25 μm.

5. The facet mirror of claim 1, wherein the actuator is a piezo-actuator.

6. The facet mirror of claim 1, further comprising:
a facet carrier having a lateral wall; and
a facet mirror frame,
wherein the actuator is a spindle drive having an external thread in the lateral surface wall of the facet carrier, the spindle drive has a threaded body carried by the facet mirror frame, the threaded body has an internal thread complementary to the external thread of the spindle drive, wherein the facet carrier is rotationally drivable via the actuator.

7. An illumination optical unit, comprising:
the facet mirror of claim 1,
wherein the illumination optical unit is configured to be used in microlithography, and the illumination optical unit is configured so that the illumination channels are superimposed in an object field.

8. An apparatus, comprising:
an illumination optical unit comprising a facet mirror according to claims 1; and
a projection optical unit having an object field,
wherein the illumination optical unit is configured so that the illumination channels are superimposed in the object field, and the apparatus is a microlithography projection exposure apparatus.

9. An illumination optical unit, comprising:
a field face mirror; and
a pupil facet mirror,
wherein the field facet mirror is a facet mirror according to claim 1, the pupil facet mirror is a facet mirror according to claim 1, and the illumination optical unit is configured to be used in microlithography.

10. An apparatus, comprising:
an illumination optical unit comprising a field facet mirror and a pupil facet mirror; and
a projection optical unit having an object field,
wherein the field facet mirror is a facet mirror according to claim 1, the pupil facet mirror is a facet mirror according to claim 1, the illumination optical unit is configured so that the illumination channels are superimposed in the object field, and the apparatus is a microlithography projection exposure apparatus.

11. A method, comprising:
providing a projection exposure apparatus comprising an illumination optical unit and a projection optical unit, the illumination optical unit comprising a facet mirror according to claim 1;
using a measuring device to measure an actual illumination intensity distribution of illumination light in the beam path of the illumination light downstream of the facet mirror, the measuring device resolving a contribution of individual illumination channels to the measured actual illumination intensity distribution,
adjusting at least one facet of the facet mirror via the actuator until an actual illumination intensity distribution over the object field corresponds to a desired illumination intensity distribution within a predefined tolerance range,
wherein the measuring device comprises a first measuring unit in the region of the object field and a second measuring unit in the region of the facet mirror.

12. The method of claim 11, wherein a field intensity predefinition device is in the region of the beam path of the illumination light, the field intensity predefinition device comprises a plurality of shading diaphragms configured to influence an illumination intensity distribution over a field height of the object field, and the method further comprises:
measuring an actual illumination intensity distribution of the illumination light over the field height via the measuring device; and
adjusting at least one facet of the facet mirror with the actuator until the actual illumination intensity distribution over the field height corresponds to a desired illumination intensity distribution within a predefined tolerance range.

13. The method of claim 11, further comprising adjusting at least one shading diaphragm until the actual illumination intensity distribution over the field height corresponds to a desired illumination intensity distribution within the predefined tolerance range.

14. A method, comprising:
providing a projection exposure apparatus comprising an illumination optical unit and a projection optical unit, the illumination optical unit comprising a field facet mirror according to claim 1, and the illumination optical unit comprising a pupil facet mirror according to claim 1;
using a measuring device to measure an actual illumination intensity distribution of illumination light in the beam path of the illumination light downstream of one of the facet mirrors, the measuring device resolving a contribution of individual illumination channels to the measured actual illumination intensity distribution,
adjusting at least one facet via the actuator until an actual illumination intensity distribution over the object field corresponds to a desired illumination intensity distribution within a predefined tolerance range,
wherein the measuring device comprises a first measuring unit in the region of the object field and a second measuring unit in the region of the pupil facet mirror.

15. The method of claim 14, wherein a field intensity predefinition device is in the region of the beam path of the illumination light, the field intensity predefinition device comprises a plurality of shading diaphragms configured to influence an illumination intensity distribution over a field height of the object field, and the method further comprises:
measuring an actual illumination intensity distribution of the illumination light over the field height via the measuring device; and
adjusting at least one facet of one of the facet mirrors with the actuator until the actual illumination intensity distribution over the field height corresponds to a desired illumination intensity distribution within a predefined tolerance range.

16. The method of claim 14, further comprising adjusting at least one shading diaphragm until the actual illumination intensity distribution over the field height corresponds to a desired illumination intensity distribution within the predefined tolerance range.

17. A method, comprising:
providing a projection exposure apparatus comprising an illumination optical unit and a projection optical unit, the illumination optical unit comprising a facet mirror according to claim 1;
using the projection exposure apparatus to project at least a part of a reticle onto a region of a light-sensitive material on a wafer.

18. The method of claim 17, further comprising making a patterned component.

19. A method, further comprising:
providing a projection exposure apparatus comprising an illumination optical unit and a projection optical unit, the illumination optical unit comprising a field facet mirror according to claim 1, and the illumination optical unit comprising a pupil facet mirror according to claim 1; and
using the projection exposure apparatus to project at least a part of a reticle onto a region of a light-sensitive material on a wafer.

20. The method of claim 19, further comprising making a patterned component.
